(19) United States
(12) Patent Application Publication
(10) Pub. No.: US 2006/0005053 A1
(43) Pub. Date: Jan. 5, 2006

(54) Cache and tag power-down function during low-power data retention standby mode technique for cached integrated circuit memory devices

(76) Inventors: Oscar Frederick Jones JR., Colorado Springs, CO (US); Douglas Blaine Butler, Colorado Springs, CO (US); Michael C. Parris, Colorado Springs, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/881,767

(22) Filed: Jun. 30, 2004

(51) Int. Cl. G06F 1/26

(52) U.S. Cl. 713/300

(57) ABSTRACT

A cache and tag power-down function during low-power data retention standby mode technique for cached integrated circuit memory devices, in particular cached dynamic random access memory (DRAM) and cached static random access memory (SRAM), wherein the data in the cache is written back from cache to the main memory arrays (write-back operation) when power-down is entered such that the cache, tag and much of the cache control logic can be powered-down during power-down standby mode. If a DRAM cache is used, the refresh cycles can be inhibited to the DRAM cache, since it has been powered-down, so that additional power savings can be realized during self-refresh power-down standby. When power-down standby is exited, the cache operations are enabled as soon as the cache, tag and control circuitry are powered-up and a clear tag sequence is executed.

### BACKGROUND OF THE INVENTION

The present invention relates, in general, to the field of integrated circuit (IC) memory devices and other devices incorporating embedded cached memory arrays. More particularly, the present invention relates to a cache and tag power-down function during low-power data retention standby mode technique for cached integrated circuit memory devices, in particular cached dynamic random access memory (DRAM) and cached static random access memory (SRAM).

Very low standby current during power-down mode has become increasingly important, especially for mobile applications which are generally battery-powered. Design methods to disable peripheral logic functions, including special power-gating circuitry, in order to reduce power-down standby current have become more prevalent, especially with advanced complementary metal oxide semiconductor (CMOS) technologies where sub-threshold currents are high. Cached DRAMs, that have a cache array included within the monolithic DRAM in order to hide refresh or provide faster input/output (I/O) access, suffer higher power-down standby current since the cache array and associated tag are powered-up in order to maintain the cached data and tag status information during power-down conditions.

Conventional cached memories require the cache and tag to be powered-up during power-down standby modes in order to retain data in cache and tag information during power-down intervals.

### SUMMARY OF THE INVENTION

Disclosed herein is a power-down method for cached memories that reduces power by powering-down cache and tag arrays while in a power-down mode. The technique of the present invention reduces power-down data retention mode current, such as when executing self-refresh power-down, by allowing the tag and cache to be powered-down during power-down intervals. Furthermore, when DRAM cache is used, further power reduction can be realized by not refreshing the cache during power-down standby operation.

The present invention defines a power-down method for cached memories wherein the data in the cache is written back from cache to the main memory arrays (write-back operation) when power-down is entered such that the cache, tag and much of the cache control logic can be powered-down during power-down standby mode. If a DRAM cache is used, the refresh cycles can be inhibited to the DRAM cache, since it has been powered-down, so that additional power savings can be realized during self-refresh power-down standby. When power-down standby is exited, the cache operations are enabled as soon as the cache, tag and control circuitry are powered-up and a clear tag sequence is executed.

As used herein, the following definitions pertain:
CLK—the input clock signal. All commands are executed on the rising, (or positive-going) transition of the clock signal;
ZZ—the power-down (Sleep Mode) control. Sleep Mode is entered on the first low-to-high transition of the CLK signal after ZZ has gone “high”. ZZ must remain “high” during Sleep Mode. Sleep Mode is exited on the first low-to-high transition of the CLK signal after ZZ has gone “low”;
CTF—Clear Tag Flag. CTF goes “high” after write-back has completed (memory array and cache coherency exists) indicating that the tag needs to be cleared. CTF goes “low” only after all tag bits have been cleared; and
REFR—Refresh Request. REFR is active “high” and inactive “low”.

Particularly disclosed herein is a method and means for reducing standby power in an integrated circuit device including a memory array and an associated data cache. The method comprises, upon initiation of entry into a standby mode, writing the data from the cache to the memory array and powering-down the cache following the writing of the data from the cache to the memory array. In more particular embodiments of the present invention, the method may further include also powering-down control logic to the cache and/or a cache tag block substantially concurrently with the powering-down of the cache. If the cache comprises DRAM the method may further comprise inhibiting refresh operations to said DRAM cache substantially concurrently with the powering-down of the cache.

Also particularly disclosed herein is a method and means for operating an integrated circuit cached memory array comprising receiving a Sleep Mode entry command, writing-back data from a cache to the memory array and entering the Sleep Mode upon completion of the writing-back of the data from the cache to the memory array. In a more particular embodiment, the method includes powering-down the cache upon completion of the writing-back of the data from the cache to the memory array.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is a functional block diagram of a representative cached DRAM memory incorporating a number of memory arrays and an associated cache array;

FIG. 2 is a timing diagram showing the clock (CLK), Sleep Mode (ZZ), Clear Tag Flag (CTF) and Refresh Request (REFR) signals during a Sleep Mode entry with a refresh request in the inactive state;

FIG. 3 is a similar timing diagram showing the same signals as in the preceding figure during a Sleep Mode entry with a refresh request in the active state;

FIG. 4 is a related timing diagram showing the same signals as in the preceding figure during a Sleep Mode entry with a refresh request going active during write-back from the cache;

FIG. 5 is a further related timing diagram showing the same signals as in the preceding figure during a Sleep Mode entry with a refresh request going active when the write-back operation is complete;

FIG. 6 is a timing diagram showing the same signals as in the preceding figure during a Sleep Mode with a hidden refresh operation;

FIG. 7 is a timing diagram showing the same signals as in the preceding figure during a Sleep Mode exit with a refresh request inactive; and

FIG. 8 is a related timing diagram showing the same signals as in the preceding figure during a Sleep Mode exit while a refresh request is active.

### DESCRIPTION OF A REPRESENTATIVE EMBODIMENT

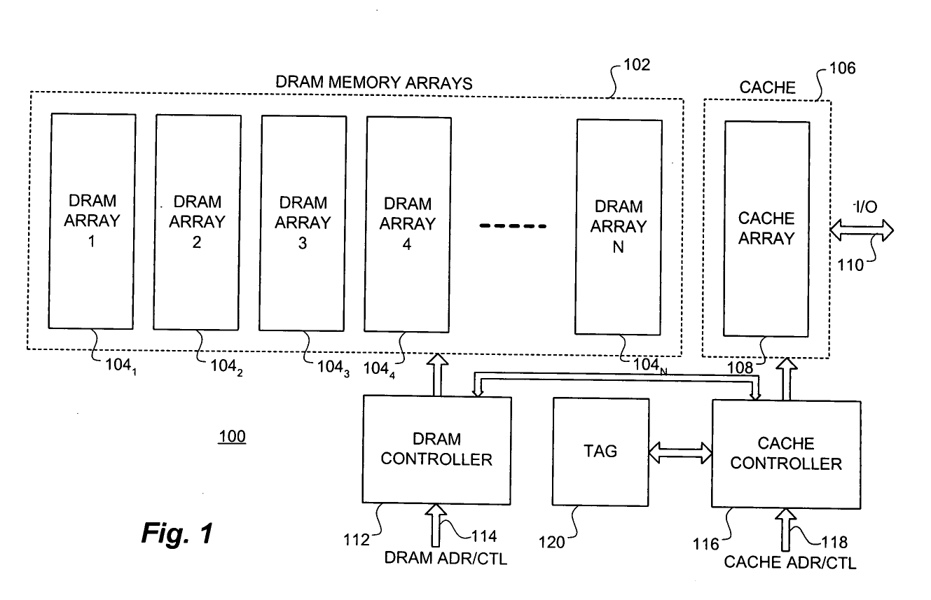

With reference now to FIG. 1, a functional block diagram of a representative cached memory 100 is shown incorporating a number of memory arrays and an associated cache array. The memory 100 (which may be a DRAM or SRAM memory IC or a device incorporating embedded DRAM or SRAM memory) includes, in the particular embodiment shown, a number of DRAM memory arrays 102, each comprising a number of DRAM arrays 104, through 104_{N} as shown.

A cache 106 is associated with, and coupled to, the DRAM memory array 102, and the former comprises one or more cache arrays 108. Data written to and read from the memory 100 on I/O bus 110 is coupled to the DRAM memory array 102 through the cache 106.

The function of the DRAM memory array 102 is controlled by a DRAM controller 112 in response to signals input on a DRAM address/control (ADR/CTL) bus 114. In like manner, the cache 106 is controlled by a cache controller 116 in response to signals input on a cache address/control bus 118. A on-chip tag block 120 is associated with the cache controller 116 for maintaining an indication of which blocks of data are currently being maintained in the cache 106.

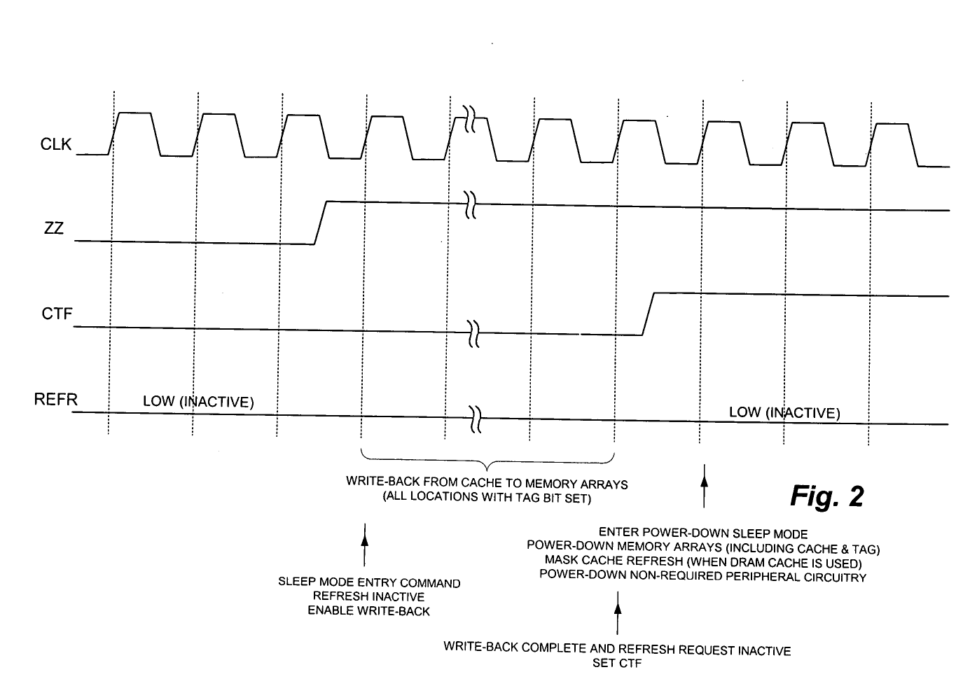

With reference additionally now to FIG. 2. a timing diagram is illustrated which shows the clock (CLK), Sleep Mode (ZZ), Clear Tag Flag (CTF) and Refresh Request (REFR) signals during a Sleep Mode entry with a refresh request in the inactive state. As indicated, on the positive-going transition of the CLK signal following assertion of the ZZ command with the REFR command inactive (e.g. “low”), a write-back operation from the cache 106 to the DRAM memory arrays 102 takes place. Upon completion of the write-back operation, and with the REFR signal still inactive, the CTF is set. Following the setting of CTF to an active state, the memory 100 enters a power-down Sleep Mode on the next positive-going transition of the CLK signal and powers-down the DRAM memory arrays 102, the cache 106 and the tag block 120. If a DRAM cache array 108 is being used, any refresh operations to the DRAM cache array 108 will then be masked and all other non-required peripheral circuitry of the memory 100 can also be powered-down at this time.

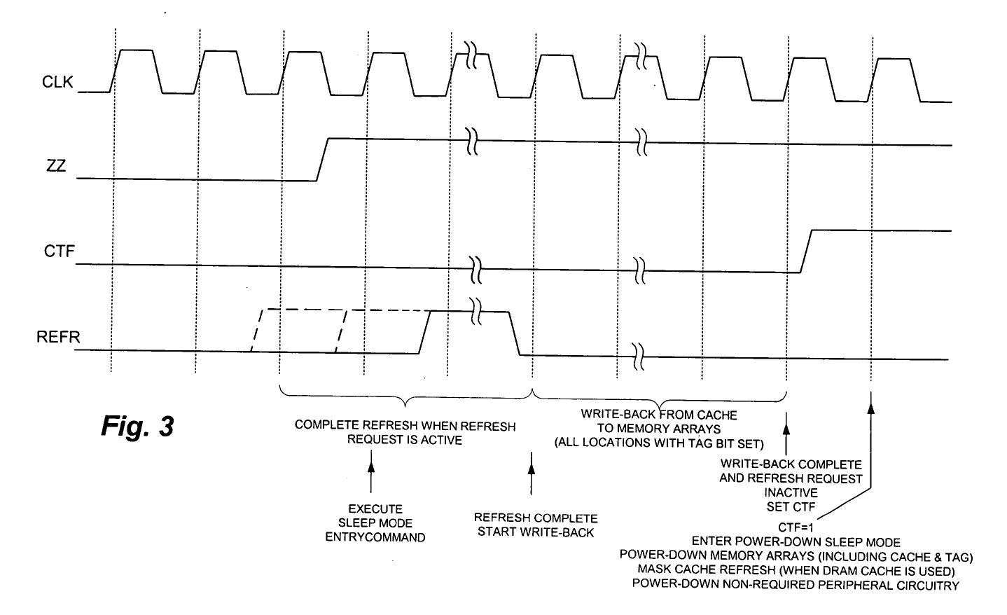

With reference additionally now to FIG. 3, a similar timing diagram is illustrated which shows the same signals as in the preceding figure during a Sleep Mode entry with a refresh request in the active state. In this figure, refresh operation is completed when the REFR signal is active and a Sleep Mode entry command is executed on the positive-going transition of the CLK signal following assertion of the ZZ command. Upon completion of the refresh operation, the write-back from the cache 106 to the DRAM memory array 102 can begin and occurs for all locations in the tag block 120 for which the appropriate tag bits are set. Upon completion of the write-back operation, and with the REFR signal in the inactive state, the CTF signal is set. On the next positive-going transition of the CLK signal following the setting of the CTF signal, the memory 100 will enter power-down Sleep Mode. At this time, the DRAM memory arrays 102, the cache 106 and the tag block 120 are also powered-down. Again, if a DRAM cache array 108 is being used, any refresh operations to the DRAM cache array 108 will then be masked and all other non-required peripheral circuitry of the memory 100 can also be powered-down at this time.

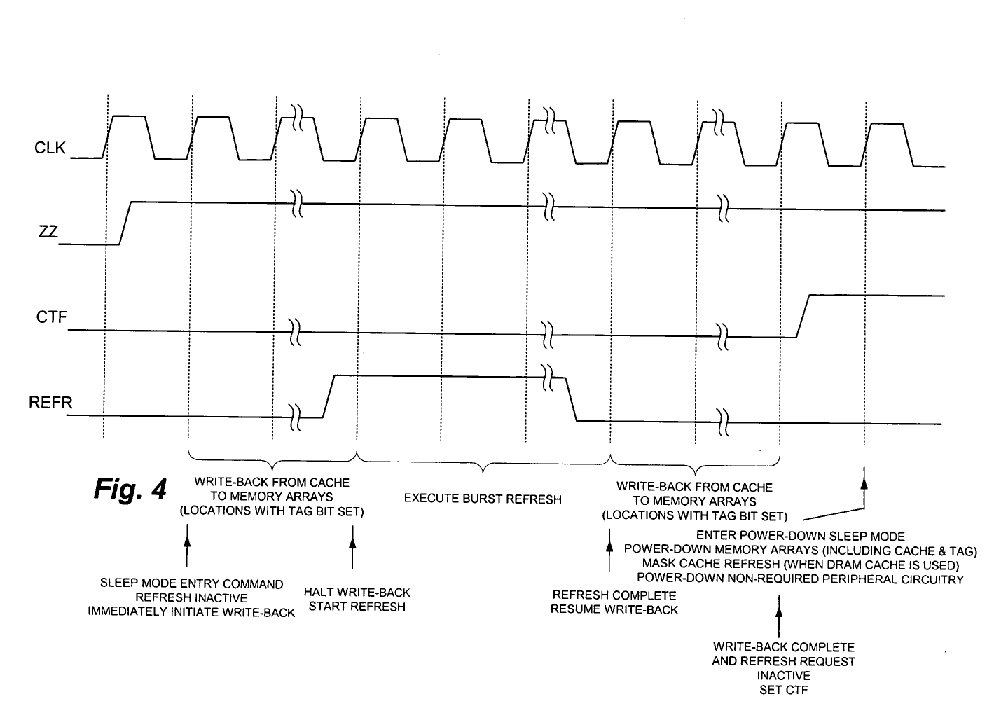

With reference additionally now to FIG. 4, a related timing diagram is illustrated which shows the same signals as in the preceding figure during a Sleep Mode entry with a refresh request going active during write-back from the cache. On the positive-going transition of the CLK signal following assertion of the ZZ signal, with the REFR signal “low” (e.g. inactive) a write-back operation is immediately initiated from the cache 106 to the DRAM memory array 102 for all locations with the tag bit set in the tag block 120. In this example, the write-back operation is halted on the positive-going transition of the CLK signal following assertion of the REFR signal and a refresh operation is begun with a burst refresh being executed. Thereafter, on the positive-going transition of the CLK signal following the deactivation of the REFR signal, the write-back operation is resumed as for those locations with the tag bit set in the tag block 120. Upon completion of the write-back operation, with the REFR signal “low”, the CTF signal is set and the memory 100 enters the power-down Sleep Mode on the next positive-going transition of the CLK signal. As before, the DRAM memory arrays 102, the cache 106 and the tag block 120 are also now powered-down. If a DRAM cache array 108 is being used, any refresh operations to the DRAM cache array 108 will then be masked and all other non-required peripheral circuitry of the memory 100 can also be powered-down at this time.

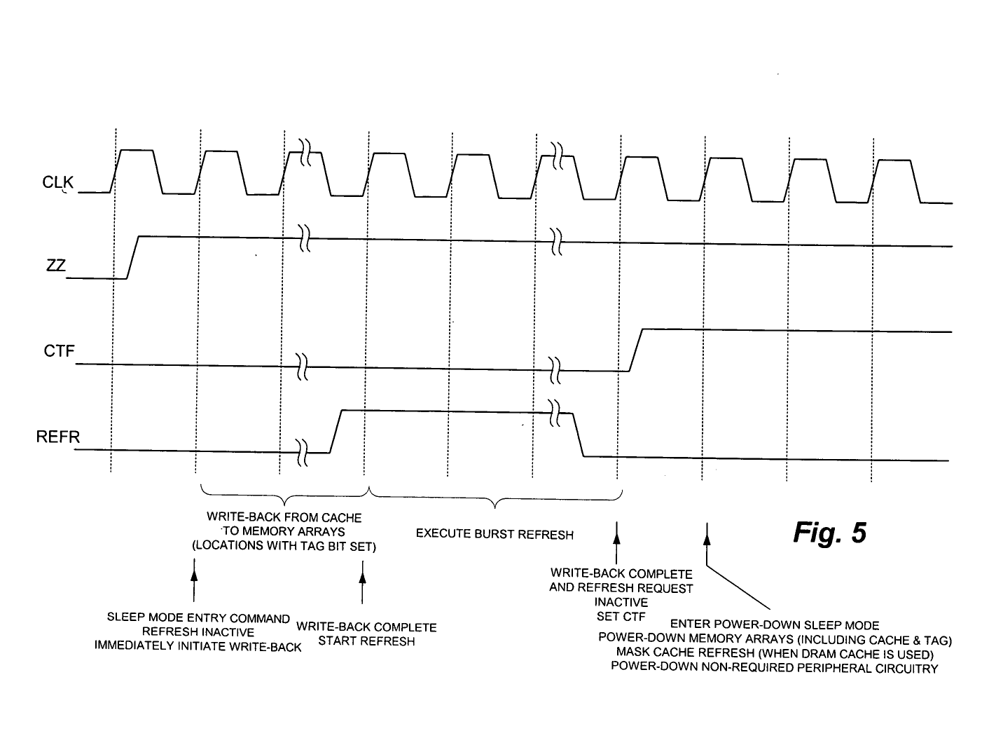

With reference additionally now to FIG. 5, a further related timing diagram is illustrated which shows the same signals as in the preceding figure during a Sleep Mode entry with a refresh request going active when the write-back operation is complete. Once again, on the positive-going transition of the CLK signal following assertion of the ZZ signal, with the REFR signal “low” (e.g. inactive) a write-back operation is immediately initiated from the cache 106 to the DRAM memory array 102 for all locations with the tag bit set in the tag block 120. In this example, the write-back operation is completed on the positive-going transition of the CLK signal following assertion of the REFR signal at which time a burst refresh operation is executed. With the write-back operation complete and the REFR signal deactivated, the CTF signal is asserted and the memory 100 enters the power-down Sleep Mode on the next positive-going transition of the CLK signal. Also as before, the DRAM memory arrays 102, the cache 106 and the tag block 120 are now powered-down, and if a DRAM cache array 108 is being used, any refresh operations to the DRAM cache array 108 will then be masked and all other non-required peripheral circuitry of the memory 100 can be powered-down at this time.

The preceding figures illustrate, in general, a self-refresh burst refresh cycle execution while in Sleep Mode and the conditions required for exiting Sleep Mode. As for Sleep Mode entry, the primary function is to execute write-back cycles wherein data which has been written to the cache 106 is written back to the main memory array 102. When the write-back operation has been completed and there is data coherency between the cache 106 and main memory 102, the cache 106 and tag block 120 can be powered-down. The power-down state is entered after the first low-to-high transition of the clock signal during which ZZ is “high”, CTF is “high” and REFR is “low”.

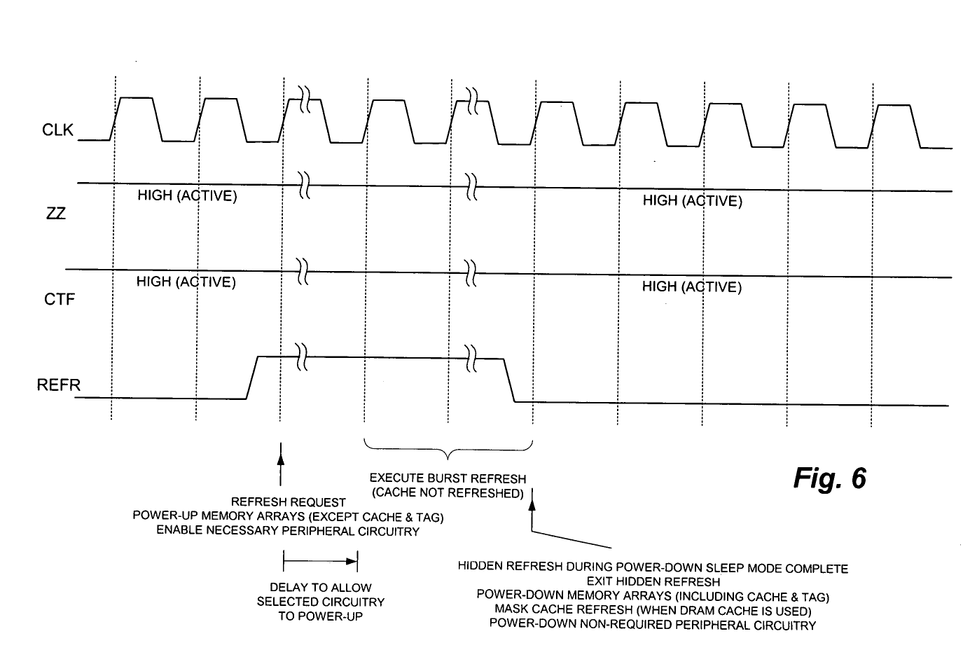

With reference additionally now to FIG. 6, a timing diagram is illustrated which shows the same signals as in the preceding figure during a Sleep Mode with a hidden refresh operation. With ZZ and CTF both “high” and REFR being asserted, on the next positive-going transition of CLK the DRAM memory arrays 102 are powered-up (and not the cache 106 and tag block 120) along with any previously powered-down peripheral circuitry of the memory 100. As shown, a single CLK cycle wait period may then be entered to allow time for this power-up operation. Following this delay period, a burst refresh operation is executed to the DRAM memory arrays 102 but not to the cache 106. At this time, with the hidden refresh during power-down Sleep Mode complete, the refresh operation is exited. Substantially concurrently, the DRAM memory arrays 102, the cache 106 and the tag block 120 are now powered-down, and if a DRAM cache array 108 is being used, any refresh operations to the DRAM cache array 108 will then be masked and all other non-required peripheral circuitry of the memory 100 can be powered-down at this time.

This figure particularly illustrates a Sleep Mode with hidden refresh operation which is equivalent to normal self-refresh cycles during Sleep Mode with the exception that not all memory arrays (when utilizing DRAM cache 106) are refreshed. Since the cache 106 is powered-down, cache 106 refresh cycles are not executed during self-refresh power-down.

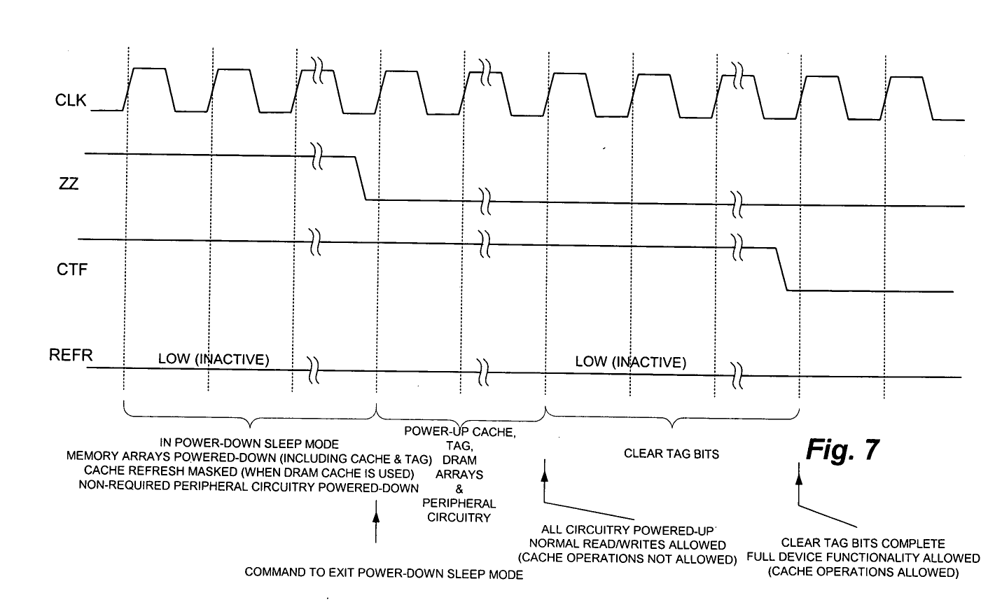

With reference additionally now to FIG. 7, a timing diagram is illustrated which shows the same signals as in the preceding figure during a Sleep Mode exit with a refresh request inactive. With ZZ asserted, CTF set and REFR “low”, the memory 100 is in power-down Sleep Mode with the DRAM memory arrays 102, the cache 106 and the tag block 120 being powered-down, and if a DRAM cache array 108 is being used, any refresh operations to the DRAM cache array 108 being masked and all other non-required peripheral circuitry of the memory 100 being also powered-down. On the positive-going transition of the CLK signal following the deassertion of the ZZ signal, the power-down Sleep Mode is exited and the cache 106, tag block 120, DRAM memory arrays 102 and any non-required peripheral circuitry previously powered-down are powered-back up. When all circuitry is again fully powered-up, normal “read” and “write” operations to the memory 100 are again allowed with the exception of cache 106 operations. At this time, the tag bits in the tag block 120 are cleared and, on the positive-going transition of the CLK signal following the deassertion of the CTF signal, the tag bit clearing operation is signal as having been completed and fully memory 100 device operation is allowed including cache 106 operations.

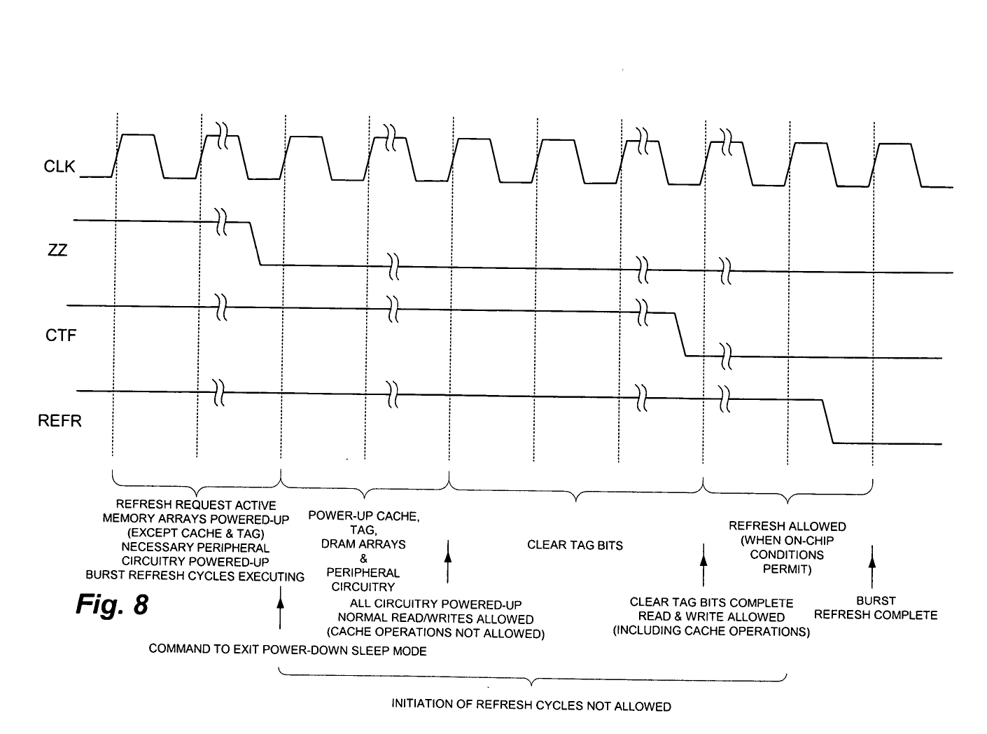

With reference additionally now to FIG. 8, a related timing diagram is illustrated which shows the same signals as in the preceding figure during a Sleep Mode exit while a refresh request is active. In this illustration, the ZZ, CTF and REFR signals are all asserted indicating that a refresh request is active, the memory arrays 102 are powered-up (not the cache 106 and tag block 120) and all necessary peripheral circuitry is powered-up with burst refresh cycles being executed. On the positive-going transition of the CLK signal following the deassertion of the ZZ signal, the cache 106 and tag block 120 are powered-up along with all peripheral circuitry not already powered-up. Once all the circuitry of the memory 100 has been powered-up, normal “read” and “write” operations can occur except for cache 106 operations. At this time, the tag bits are cleared and, on the positive-going transition of the CLK signal following deassertion of the CTF signal, the clearing operation is completed and “read” and “write” operations can occur to both the memory arrays 102 as well as the cache 106. At this point a refresh operation is allowed, should on-chip conditions so permit and a burst refresh is completed on the positive-going transition of the CLK signal following the deassertion of the REFR signal. For the time period indicated commencing with the positive-going transition of the CLK signal following the deassertion of the ZZ signal, the initiation of refresh cycles is not allowed.

Both this figure and the preceding one illustrate Sleep Mode exit. The embodiment of the present invention illustrated and described contemplates two main operations to occur during power-down exit. The first operation is to power-up all circuitry, including the cache 106 and tag block 120. The second operation is to clear all tag bits. Once these two operations have been completed, full operation of the memory 100 device is allowed, including cache 106 operations.

While there have been described above the principles of the present invention in conjunction with specifically designated signals and corresponding states for asserting and deasserting the same, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicants hereby reserve the right to formulate new claims to such features and/or combinations of such features during the prosecution of the present application or of any further application derived therefrom.

What is claimed is:

1. A method for reducing standby power in an integrated circuit device including a memory array and an associated data cache, said method comprising:
upon initiation of entry into a standby mode, writing said data from said cache to said memory array; and
powering-down said cache following said writing of said data from said cache to said memory array.

2. The method of claim 1 further comprising:
also powering-down control logic to said cache substantially concurrently with powering-down said cache.

3. The method of claim 2 further comprising:
additionally powering-down a cache tag block associated with said cache substantially concurrently with powering-down said cache.

4. The method of claim 1 wherein said cache comprises dynamic random access memory (DRAM) and said method further comprises:
inhibiting refresh operations to said DRAM cache substantially concurrently with powering-down said cache.

5. The method of claim 1 further comprising:
upon exit from said standby mode, powering-up said cache.

6. The method of claim 2 further comprising:
upon exit from said standby mode, powering-up said control logic to said cache.

7. The method of claim 3 further comprising:
upon exit from said standby mode, powering-up said cache tag block.

8. The method of claim 4 further comprising:
upon exit from said standby mode, enabling said refresh operations to said DRAM cache.

9. A method for operating an integrated circuit cached memory array comprising:
receiving a Sleep Mode entry command;
writing-back data from a cache to said memory array; and
entering said Sleep Mode upon completion of said writing-back of said data from said cache to said memory array.

10. The method of claim 9 further comprising:
powering-down said cache upon completion of said writing-back of said data from said cache to said memory array.

11. The method of claim 10 further comprising:
inhibiting any refresh operations to said cache upon powering-down of said cache.

12. The method of claim 10 further comprising:
also powering-down control logic to said cache upon powering-down of said cache.

13. The method of claim 10 further comprising:
also powering-down a cache tag block upon powering-down of said cache.

14. The method of claim 10 further comprising:
also powering-down at least a portion of other circuitry peripheral to said memory array not required for maintaining said data in said memory array during said Sleep Mode.

15. The method of claim 9 further comprising:
if said memory array is being refreshed when said Sleep Mode entry command is received, completing a refresh operation to said memory array prior to writing-back said data from said cache to said memory array.

16. The method of claim 9 further comprising:
suspending said writing-back of said data from said cache to said memory array if a refresh operation to said memory array occurs subsequent to initiation of said writing-back of said data; and
completing said writing-back of said data upon completion of said refresh operation.

17. The method of claim 9 further comprising:
continuing periodic refresh operations to said memory array while in said Sleep Mode.

18. The method of claim 10 further comprising:
upon exit from said Sleep Mode, powering-up said cache.

19. The method of claim 11 further comprising:
upon exit from said Sleep Mode, enabling any refresh operations to said cache.

20. The method of claim 12 further comprising:
upon exit from said Sleep Mode, powering-up said control logic to said cache.

21. The method of claim 13 further comprising:
upon exit from said Sleep Mode, powering-up said cache tag block.

22. The method of claim 14 further comprising:
upon exit from said Sleep Mode, powering-up said at least a portion of said other circuitry peripheral to said memory array.

23. The method of claim 21 further comprising:
clearing tag bits associated with said cache tag block; and
subsequently enabling operations to said cache.

24. An integrated circuit device including a memory array and an associated data cache, said device comprising:
means for writing said data from said cache to said memory array upon initiation of entry into a standby mode; and
means for powering-down said cache following said writing of said data from said cache to said memory array.

25. The integrated circuit device of claim 24 further comprising:
means for also powering-down control logic to said cache substantially concurrently with powering-down said cache.

26. The integrated circuit device of claim 25 further comprising:
means for additionally powering-down a cache tag block associated with said cache substantially concurrently with powering-down said cache.

27. The integrated circuit device of claim 24 wherein said cache comprises dynamic random access memory (DRAM) and said device further comprises:
means for inhibiting refresh operations to said DRAM cache substantially concurrently with powering-down said cache.

28. The integrated circuit device of claim 24 further comprising:
means for powering-up said cache upon exit from said standby mode.

29. The integrated circuit device of claim 25 further comprising:
means for powering-up said control logic to said cache upon exit from said standby mode.

30. The integrated circuit device of claim 26 further comprising:
means for powering-up said cache tag block upon exit from said standby mode.

31. The integrated circuit device of claim 27 further comprising:
means for enabling said refresh operations to said DRAM cache upon exit from said standby mode.

32. An integrated circuit device including a cached memory array, said device comprising:
means for receiving a Sleep Mode entry command;
means for writing-back data from a cache to said memory array; and
means for entering said Sleep Mode upon completion of said writing-back of said data from said cache to said memory array.

33. The integrated circuit device of claim 32 further comprising:
means for powering-down said cache upon completion of said writing-back of said data from said cache to said memory array.

34. The integrated circuit device of claim 33 further comprising:
means for inhibiting any refresh operations to said cache upon powering-down of said cache.

35. The integrated circuit device of claim 33 further comprising:
means for also powering-down control logic to said cache upon powering-down of said cache.

36. The integrated circuit device of claim 33 further comprising:
means for also powering-down a cache tag block upon powering-down of said cache.

37. The integrated circuit device of claim 33 further comprising:
means for also powering-down at least a portion of other circuitry peripheral to said memory array not required for maintaining said data in said memory array during said Sleep Mode.

38. The integrated circuit device of claim 32 further comprising:
means for completing a refresh operation to said memory array prior to writing-back said data from said cache to said memory array if said memory array is being refreshed when said Sleep Mode entry command is received.

39. The integrated circuit device of claim 32 further comprising:
means for suspending said writing-back of said data from said cache to said memory array if a refresh operation to said memory array occurs subsequent to initiation of said writing-back of said data; and
means for completing said writing-back of said data upon completion of said refresh operation.

40. The integrated circuit device of claim 32 further comprising:
means for continuing periodic refresh operations to said memory array while in said Sleep Mode.

41. The integrated circuit device of claim 33 further comprising:
means for powering-up said cache upon exit from said Sleep Mode.

42. The integrated circuit device of claim 34 further comprising:
means for enabling any refresh operations to said cache upon exit from said Sleep Mode.

43. The integrated circuit device of claim 35 further comprising:
means for powering-up said control logic to said cache upon exit from said Sleep Mode.

44. The integrated circuit device of claim 36 further comprising:
means for powering-up said cache tag block upon exit from said Sleep Mode.

45. The integrated circuit device of claim 37 further comprising:
means for powering-up said at least a portion of said other circuitry peripheral to said memory array upon exit from said Sleep Mode.

46. The integrated circuit device of claim 44 further comprising:
means for clearing tag bits associated with said cache tag block; and
means for subsequently enabling operations to said cache.
